(19) United States
(12) Patent Application Publication
(10) Pub. No.: US 2006/0065620 A1
(43) Pub. Date: Mar. 30, 2006

(54) Well use of space for low resistance coil design for write head

(76) Inventors: Edward Hin Pong Lee, San Jose, CA (US); Vladimir Nikitin, Campbell, CA (US)

Correspondence Address: Maryam Imam, Esq.;LAW OFFICES OF IMAM, Suite 1010, 111 North Market Street, San Jose, CA, 95113, US

(21) Appl. No.: 11/280,846

(22) Filed: Nov. 15, 2005

Related U.S. Application Data
(63) Continuation-in-part of application No. 10/652,878, filed on Aug. 29, 2003.

(51) Int. Cl. B44C 1/22; C03C 15/00; G11B 5/127; G11B 5/33

(52) U.S. Cl. 216/22; 360/110; 216/88; 216/41; 360/313

(57) ABSTRACT

In one embodiment of the present invention, a write head includes a P2 pole tip, a back gap layer, and a first insulation layer applied on top and in between the P2 pole tip and the back gap layer. Coil, formed of copper, is developed on top of the first insulation layer and extends below the top of the P2 pole tip, a second insulation layer pancakes the coil to insulate it. A P3 magnetic layer is formed on top of the second insulation layer, the coil reducing coil resistance yet avoiding shorting with the P3 magnetic layer.

### CROSS REFERENCE TO RELATED APPLICATIONS

This application is a continuation-in-part of prior U.S. patent application Ser. No. 10/652,878, filed on Aug. 29, 2003, entitled “METHOD FOR PATTERNING A SELF-ALIGNED COIL USING A DAMASCENE PROCESS”, the contents of which is incorporated herein by reference as though set forth in full and related to U.S. patent application Ser. No. 11/243,731, filed on Oct. 4, 2005 and entitled “SELF-ALIGNED COIL PROCESS IN MAGNETIC RECORDING HEADS”, the contents of which is incorporated herein by reference, as though set forth in full.

### BACKGROUND OF THE INVENTION

1. Field of the Invention

This invention relates generally to the field of magnetic recording heads having coils inducing magnetic flux for writing on a magnetic medium (such as a magnetic disc) and more particularly, to recording heads having coil sizes taller in height causing lower coil resistance and thereby minimal write-induced protrusion.

2. Description of the Prior Art

Magnetic hard drives (or disc drives) have been in common use for storage of large groups of data for decades. Improvements in manufacturing thereof has attracted popular attention particularly to reducing the size of the drive and/or its internal components to achieve both lower costs and wider applications.

Magnetic hard drives include magnetic recording head for reading and writing of data. As well known, a magnetic recording head generally includes two portions, a write head portion or head for writing or programming magnetically-encoded information on a magnetic media or disc and a reader portion for reading or retrieving the stored information from the media.

Data is written onto a disc by a write head that includes a magnetic yoke having a coil passing there through. When current flows through the coil, a magnetic flux is induced in the yoke, which causes a magnetic field to fringe out at a write gap in a pole tip region. It is this magnetic field that writes data, in the form of magnetic transitions, onto the disk. Currently, such heads are thin film magnetic heads, constructed using material deposition techniques such as sputtering and electroplating, along with photolithographic techniques, and wet and dry etching techniques.

Examples of such thin film heads include a first magnetic pole, formed of a material such as NiFe which might be plated onto a substrate after sputter depositing an electrically conductive seed layer. Opposite the pole tip region, at a back end of the magnetic pole, a magnetic back gap can be formed. A back gap is the term generally used to describe a magnetic structure that magnetically connects first and second poles to form a completed magnetic yoke, as will be described.

One or more electrically conductive coils can be formed over the first pole, between the pedestal and the back gap and can be electrically isolated from the pole and yoke by an insulation layer, which could be alumina (Al₂O₃) or hard baked photoresist.

With reference to FIG. 1, a plan view of an exemplary write element 302 can be seen in relation to the slider 111. A coil 304, passing through a magnetic yoke 306, induces a magnetic flux in the yoke 306. The magnetic flux in the yoke 306, in turn causes a magnetic field to fringe out at the pole tip 308. It is this fringing field 310 that writes magnetic signals onto a nearby magnetic medium.

With reference now to FIG. 2, a magnetic head 400 according to one possible embodiment of the present invention has magnetic read element 402 sandwiched between first and second magnetic shields, 404 and 406. A write head, generally referred to as 408, includes a first pole P1 410. A P1 pedestal 412 disposed in a pole tip region 413 and a first back gap layer 414, at an opposite end, are formed over the first pole. The first pole 410, P1 pedestal 412, and back gap 414 are formed of a magnetic material such as for example NiFe. A first coil insulation layer 416 is formed over the first pole 410 between the P1 pedestal 412 and back gap layer 414. An electrically conductive coil 418, shown in partial cross section in FIG. 2, passes over the first pole 410 on top of the first insulation layer 416. A second coil insulation layer 420 insulates the turns of the coil 418 from one another and insulates the coil from the rest of the write head 408.

With continued reference to FIG. 2, a thin layer of non-magnetic write gap layer 424 is deposited over the coil 418, insulation layer 420 and P1 pedestal 412, and extends to an air bearing surface (ABS) 426 at one end and stops short of extending completely over the top of the back gap layer 414 at the other end. A magnetic second back gap material layer 428 may be formed over the top of the back gap layer 414, being magnetically connected therewith. The ABS is the surface of the magnetic head designed such that it enables the magnetic head to ride on a cushion of air between the head and the disc along the disc surface.

With continued reference to FIG. 2, a P2 pole tip 430 is provided on top of the write gap layer 424 in the pole tip region 413. The P2 pole tip 430 extends to the ABS 426, and has a width (into the page of FIG. 2) that defines a track width of the write head 408. The P2 pole tip is constructed of a magnetic material, and is preferably constructed of a soft magnetic material having a high magnetic saturation (high Bsat) and low coercivity.

With reference still to FIG. 2, a dielectric material such as alumina extends from the P2 pole tip 430 to the second back gap layer 428. The P2 pole tip 430 and the second back gap layer 428 may be formed at the same time or during the same step of processing, alternatively, they may be formed separately, as disclosed hereinabove. A second coil 434 sits atop the dielectric layer, and is insulated by an insulation layer 436, which could be for example hard baked photoresist. A P3 magnetic layer 438 is formed above the second coil 434 and the insulation layer 436 and extends from the P2 pole tip 430 to the second back gap layer 428 being magnetically connected with both. The P3 magnetic layer 438 forms the majority of a second pole of the magnetic yoke of the write head 408.

The pole tip region 426, the P3 magnetic layer 438 and the back gap 414 form the magnetic yoke (or yoke) referred to in the foregoing and below. It is desirable to maintain a short yoke length to keep the magnetic path short and thus to minimize magnetic leakage and to achieve high data rate for better performance. It is through the pole tip region 426 that the field 310 (in FIG. 1) fringes to write magnetic signals onto the medium or disc.

An area 439, in FIG. 2, is shown, filled with alumina and basically wasted space, this is important in that, as later discussed, the area 439 is used by the present invention to provide for taller coil size thereby reducing coil resistance.

In the prior art write head 400, the P2 pole tip 430 is shown residing below the P3 magnetic layer 438 and in fact, connected thereto via chemical mechanical polishing (CMP) process, in other prior art write heads, the P2 pole tip 430 extends all the way across forming a P2 layer without the P3 magnetic layer 438.

As those skilled in the art will appreciate, the coil 418 and the second coil 434 are critical elements of the write or recording head because they form the coil 304 of FIG. 1, passing through the magnetic yoke 306 (in FIG. 1), to induce a magnetic flux in the yoke 306. The magnetic flux in the yoke 306, in turn, causes a magnetic field to fringe out at the pole tip 308, as earlier discussed. It is this fringing field 310 that writes magnetic signals onto a nearby magnetic medium.

The problem with prior art write heads is that since it is desirable to keep the yoke length short, the coil (coils 418 and 434) needs to be narrow in an effort to attain an appropriate number of turns of the coil. The narrowness of the coil causes the coil resistance to be high. Therefore, the write head can become hotter during write operations thereby causing expansion and protrusion of the write head. This protrusion is likely to cause the write poles to protrude too close to the disc, potentially causing scratching of the disc.

In some prior art techniques, problems associated with the height of the coil include but are not limited to the following. The distance between the write head (shown generally at 433) and the read head (shown generally at 431), in magnetic head 400, is substantially increased. Additionally, the coil 434 shorts with the P3 magnetic layer 438 because as the coil turns are increased in height and become closer to the P3 magnetic layer 438, the insulation layer 436, particularly, at areas 437, becomes thin. During the removal of the seed layer of the P3 magnetic layer 438, the coil at areas 437 can easily be exposed and the shorting of the coil to P3 layer can result. Such shorting is clearly undesirable for many reasons, among which is a high potential for corrosion.

Therefore, the need arises for a write head of a disc drive to have a coil tall enough to have low resistance yet avoid corrosion.

### SUMMARY OF THE INVENTION

Briefly, in one embodiment of the present invention and a method for manufacturing the same includes a structure formed in a write head is shown to have a P2 pole tip, a back gap layer, and a first insulation layer applied on top and in between the P2 pole tip and the back gap layer. Coil, formed of copper, is developed on top of the first insulation layer and extends below the top of the P2 pole tip, a second insulation layer pancakes the coil to insulate it. A P3 magnetic layer is formed on top of the second insulation layer, the coil reducing coil resistance yet avoiding shorting with the P3 magnetic layer.

### IN THE DRAWINGS

FIG. 1 illustrates a plan view of an exemplary prior art write element 302 that can be seen in relation to the slider 111.

FIG. 2 shows a magnetic head 400 according to one possible embodiment of the present invention having magnetic read element 402 sandwiched between first and second magnetic shields, 404 and 406.

FIG. 3 shows a top perspective view of a disc drive 100 embodying this invention is shown in accordance with an embodiment of the present invention.

FIG. 4 shows further structures of the disc drive 100 in accordance with an embodiment of the present invention.

FIG. 5 shows a plan view of an exemplary magnetic write (or recording) head 500 in accordance with one possible embodiment of the present invention.

FIGS. 6(a)-(f) show some of the relevant steps for processing or manufacturing the write head 508 to increase the height of the coil 534.

FIGS. 7(a)-(c) show the relevant steps for an alternative formation and embodiment of the write head 508.

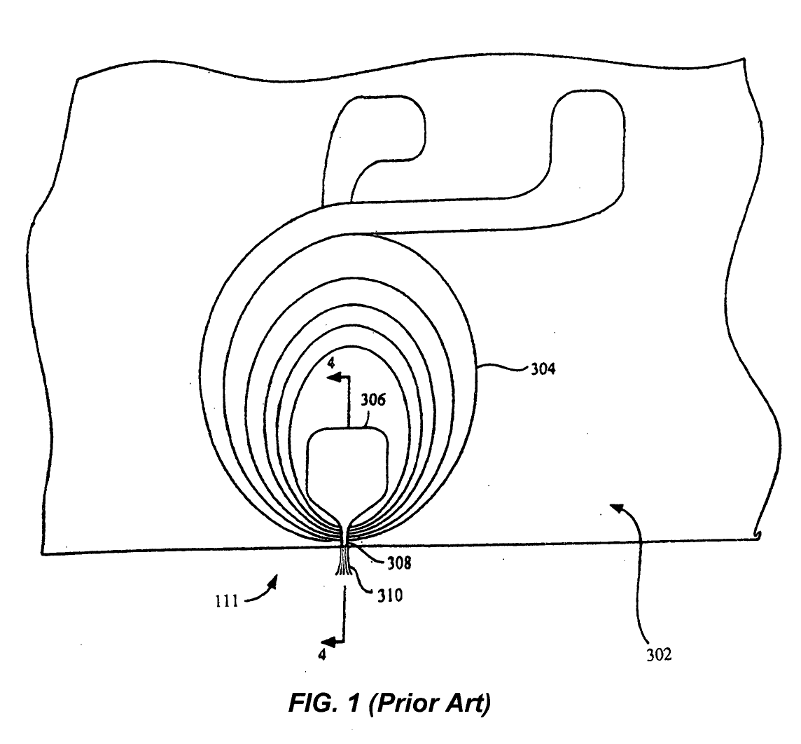

### DETAILED DESCRIPTION OF THE PREFERRED EMBODIMENT

The following description is the best embodiment presently contemplated for carrying out this invention. This description is made for the purpose of illustrating the general principles of this invention and is not meant to limit the inventive concepts claimed herein.

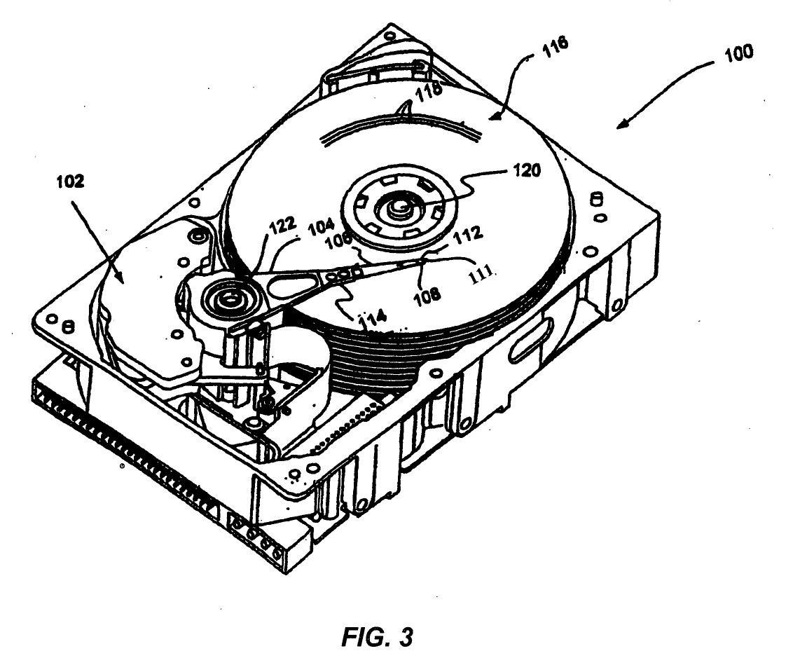

Referring now to FIG. 3, a top perspective view of a disc drive 100 embodying this invention is shown in accordance with an embodiment of the present invention. The disc drive 100 is shown to include a voice coil motor (VCM) 102, an actuator arm 104, a suspension 106, a flexure 108, a slider 111, a read-write head 112, a head mounting block 114, and magnetic disc or media 116. Suspension 106 is connected to the actuator arm 104 at the head mounting block 114. The actuator arm 104 is coupled to the VCM 102. The disc 116 includes a plurality of tracks 118 and rotates about axis 120. The tracks 118 are circular, each extending circularly around the surface of the disc 116 for storing magnetically-encoded data or information using the head 112, which will be discussed in greater detail with respect to further figures.

During operation of the disc drive 100, rotation of the disc 116 generates air movement which is encountered by the slider 111. This air movement acts to keep the slider 111 afloat a small distance above the surface of the disc 116, allowing the slider 111 to fly above the surface of the disc 116. The VCM 102 is selectively operated to move the actuator arm 104 around the axis 120, thereby moving the suspension 106 and positioning the transducing head (not shown), which includes a main pole (not shown), by the slider 111 over the tracks 118 of the disc 116. It is imperative to position the transducing head properly to read and write data from and to the concentric tracks 118.

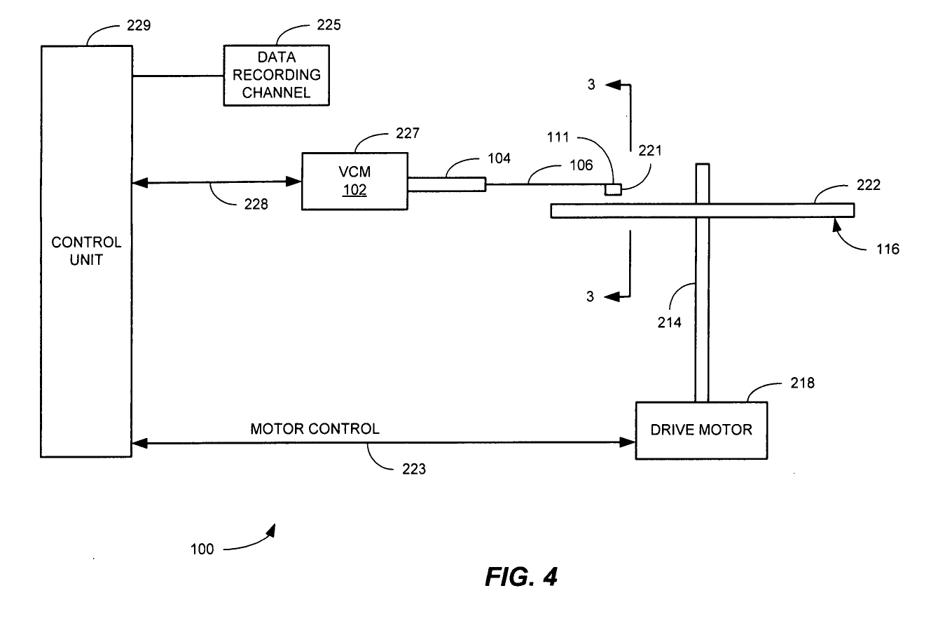

With reference now to FIG. 4, further structures of the disc drive 100 are shown in accordance with an embodiment of the present invention. As shown in FIG. 4, at least one rotatable magnetic disc 116 is supported on a spindle 214 and rotated by a disc drive motor 218. The magnetic recording on each disc is in the form of an annular pattern of concentric data tracks (not shown in FIG. 4) on the disc 116.

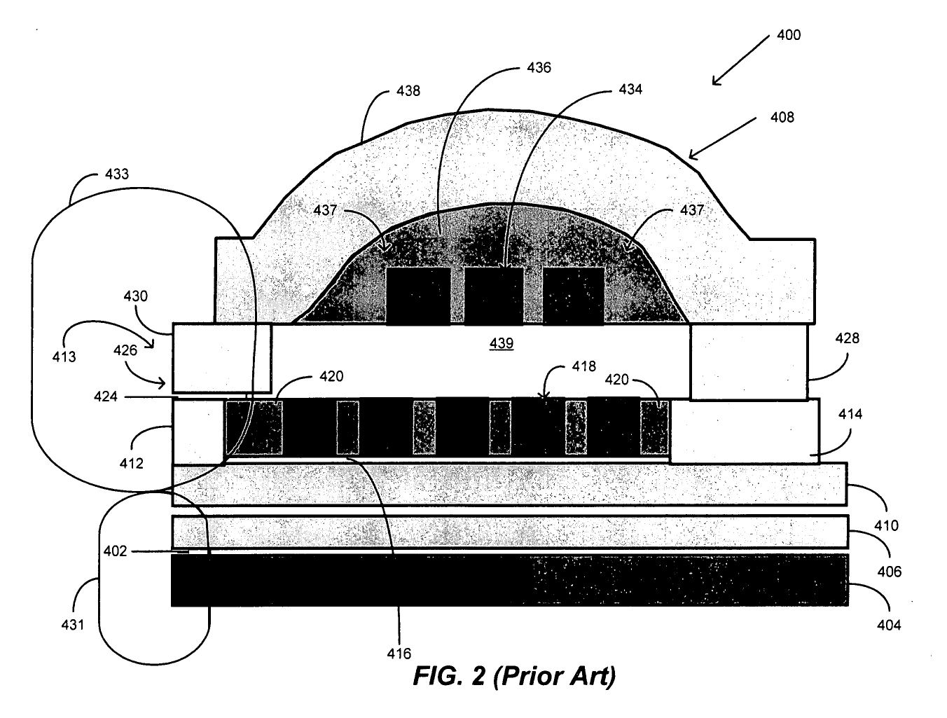

At least one slider 111 is positioned near the magnetic disc 116, each slider 111 supporting one or more magnetic head assemblies 221. As the magnetic disc rotates, the slider 111 is moved radially in and out over the disc surface 222 so that the magnetic head assembly 221 may access different tracks of the magnetic disc where desired data are written. Each slider 111 is attached to the actuator arm 104 by way of a suspension 106. The suspension 106 provides a slight spring force which biases slider 111 against the disc surface 222. Each actuator arm 104 is attached to an actuator means 227. The actuator means 227, as shown in FIG. 2, may be the VCM 102. The VCM 102 comprises a coil movable within a fixed magnetic field, the direction and speed of the coil movements being controlled by the motor current signals supplied by the controller 229.

During operation of the disc storage system or disc drive 100, the rotation of the disc 116 generates an air bearing between the slider 111 and the disc surface 222 which exerts an upward force or lift on the slider. The air bearing thus counter-balances the slight spring force of the suspension 106 and supports the slider 111 off and slightly above the disc surface by a small, substantially constant spacing during normal operation.

The various components of the disc storage system are controlled in operation by control signals generated by the control unit 229, such as access control signals and internal clock signals. Typically, the control unit 229 comprises logic control circuits, storage means and a microprocessor. The control unit 229 generates control signals to control various system operations such as drive motor control signals on line 223 and head position and seek control signals on line 228. The control signals on line 228 provide the desired current profiles to optimally move and position slider 111 to the desired data track on the disc 116. Write and read signals are communicated to and from write and read heads 221 by way of recording channel 225.

The above description of a typical magnetic disk storage system, and the accompanying illustration of FIG. 4 are for representation purposes only. It should be apparent that disc storage systems may contain a large number of discs and actuators, and each actuator may support a number of sliders. It should be noted that the term “disc”, as used herein, is the same as the term “disk”, as known to those of ordinary skill in the art, in fact, the terms “disc” and “disk” are used interchangeably herein.

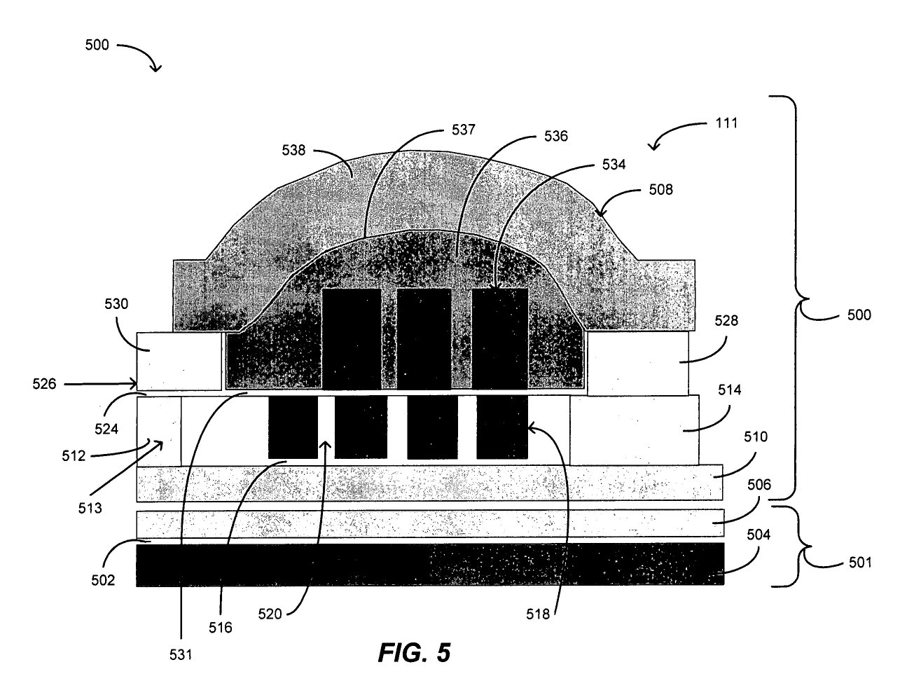

This invention provides an improved structure and method of fabrication of the write head. With reference to FIG. 5, a plan view of a portion of an exemplary slider 111 including a read head 501 and write head 500 is shown in accordance with one possible embodiment of the present invention. To provide perspective, the write head portion 500 of FIG. 5 is a part of the slider 111 of FIG. 4, operational in a disk drive, such as the disc drive 100.

The read head 501 is shown to include magnetic read element 502 sandwiched between first and second magnetic shields, 504 and 506. A write head, generally referred to as 508, includes a first pole P1 510. A P1 pedestal 512 disposed at the air bearing surface (ABS) 526 and a first back gap layer 514, at an opposite end, are formed over the first pole. The first pole 510, P1 pedestal 512, and back gap layer 514 are formed of a magnetic material such as for example NiFe. A first coil insulation layer 516 is formed over the first pole 510 between the P1 pedestal 512 and the back gap layer 514. In one method of manufacturing the write head 500, the back gap layer 514 is made at the same time as the P1 pedestal 512. However, in other methods of manufacturing the same, the back gap layer 514 is made separately. In one embodiment of the present invention, the back gap layer 514 may be made of nickel iron (NiFe) alloys, cobolt iron (CoFe) alloys, or cobolt iron nickel (CoFeNi) alloys. An electrically conductive coil layer 518, shown in partial cross section in FIG. 5, is plated over the first pole 510 on top of the first barrier/seed insulation layer 516 in the coil pockets (reference number 518 refers to the coil pockets after they have been filled with the coil layer). The coil material may be deposited in the coil pockets by plating or other deposition techniques. The coil turns induce a magnetic flux in the yoke which is used to generate the write filed used to record magnetic transitions on the media. The number of coil turns is dependent on the specifics of the design of the head. The greater the number of turns, the greater the generated flux but also greater inductance and resistance (since each coil turn has to be narrower). One solution to this problem is presented in the U.S. patent application Ser. No. 10/652,878, by the same inventors, filed on Aug. 29, 2003, entitled “Method For Patterning A Self-Aligned Coil Using A Damascene Process”, the disclosure of which is incorporated herein by reference, as though set forth in full.

In one embodiment of the present invention, the first insulation layer 516 is made by the deposition of a layer of alumina (Al₂O₃) or silicon dioxide (SiO₂) followed by the deposition of a seed layer (e.g. Rhodium), and the coil 518 is made of copper. A second coil insulation layer 520 insulates the turns of the coil 518 from one another and insulates the coil from the rest of the write head 508. In one embodiment of the present invention, the second coil insulation layer 520 is hard baked photoresist.

The embodiment of FIG. 5 presents a non-damascene structure and method of manufacturing the same for reducing recession of the P1 pedestal, as will be evident shortly. However, a brief discussion of the advantage of the write head 500 and manufacturing thereof over that of a damascene method is presented. In damascene techniques, various ways of manufacturing coil within coil pockets that are self-aligned are employed but these methods require added effort and more extensive manufacturing details that are not required by the embodiments of the present invention. The damascene technique of coil formation may require for example, a tri-layer method including an imaging layer, a dielectric layer, and hard bake resist. An alternative embodiment may consist of a bi-layer method including an imaging layer and dielectric layer. However, the manufacturing of the write head 500 according to one aspect of the present invention does not require the complexities of the damascene technique and at the same time it allows for the formation of tall coils having lower resistance.

With continued reference to FIG. 5, a thin layer of non-magnetic write gap layer 524 is deposited over the coil 518, insulation layers 520 and P1 pedestal 512, and extends to an air bearing surface (ABS) 526 at one end and stops short of extending completely over the top of the back gap layer 514 at the other end. The layer 524 may be made of a metallic non-magnetic material or a non-metallic non-magnetic material. A magnetic second back gap material layer 528, also referred to as a back gap pedestal, may be formed over the top of the back gap layer 514, being magnetically connected therewith. The ABS is the surface of the magnetic head immediately adjacent to the perpendicular medium or stated slightly differently, the surface of the magnetic head, which is parallel to the disk (or medium) surface and rides on a cushion of air between the head and the disc.

With continued reference to FIG. 5, a P2 pole tip 530 is provided on top of the write gap layer 524 in the pole tip region 513. The P2 pole tip 530 extends to the ABS 526, and has a width (into the page of FIG. 5) that defines a track width of the write head 508. The P2 pole tip is constructed of a magnetic material, and is preferably constructed of a soft magnetic material having a high magnetic saturation (high Bsat) and low coercivity.

With reference still to FIG. 5, a dielectric material (or layer) 531, such as alumina, extends from the P2 pole tip 530 to the second back gap layer 528. A second coil 534 sits atop the dielectric material layer 531, and is insulated by an insulation layer 536, which could be, for example, hard baked photoresist. A P3 magnetic layer 538 is formed above the second coil 534 and the insulation layer 536 and extends from the P2 pole tip 530 to the second back gap layer 528 being magnetically connected with both. The P3 magnetic layer 538 forms the majority of a second pole of the magnetic yoke of the write head 508. Further details of the process for manufacturing the relevant portions of the write head 508 are presented shortly relative to other figures.

As noted in a comparison of FIGS. 5 and 2, while not drawn to scale, the coil 534 is larger in height, i.e. taller, than that of the coil 434 of FIG. 2. That is, the area 439 of FIG. 2 is now, in large part, consumed by the coil 534. In fact, the percentage of conductive material within the area defined above the layer 524 and below the P3 magnetic layer 538 and extending between the P2 pole tip 530 and the layer 528 is 40 to 50%, whereas, the percentage of non-conductive material within the same area is 50 to 60%. Thus, the ratio of conductive material (copper) to non-conductive material (insulation layer 536, which may be made of AlO₃) within this area is about 1:1. Moreover, the aspect ratio of coil 534, which is the ratio of the height of the coil to its width is changed by 100% in the present invention over that of prior art. The same hold true of the coil 628. Furthermore, it should further be noted that the coil 534 of FIG. 5, is shown to extend below the top of the P2 pole tip 530, which is not the case in prior art structures, such as that shown in FIG. 2.

Thus, the write head 500 is structured to optimally increase conductivity and well use of space for building taller coils is made possible, which prevents any increase in the size of the P1 pedestal 512 or P2 pole tip 530. To this end, the coil 534 allows for a lower coil resistance than its counterpart prior art coil 434, which is highly desirable for reasons discussed hereinabove. Furthermore, there is no shorting of the coil 534 with the P3 magnetic layer 538 as the insulation layer 536 prevents the same, as the coil 534 is formed tall atop the layer 531. The taller coil 534 allows for copper coils that occupy a larger percentage of the available area leading to lower resistance and inductance.

A seed layer 537 is sputtered onto the insulation layer 536 and during the removal of this seed layer, which is after the P3 formation process, the coil 534 is not exposed to cause a short, as done by prior art techniques.

Moreover, the distance between the write head 500 and the read head 501, specifically the distance between the write gap layer 524 and the read element 502 remains almost, if not, the same as that of FIG. 2. This is because the height of the P1 pedestal 512 remains substantially the same as that of prior art structures. Remaining figures will now be discussed to provide further details of the steps for manufacturing the relevant portions of the write head 508.

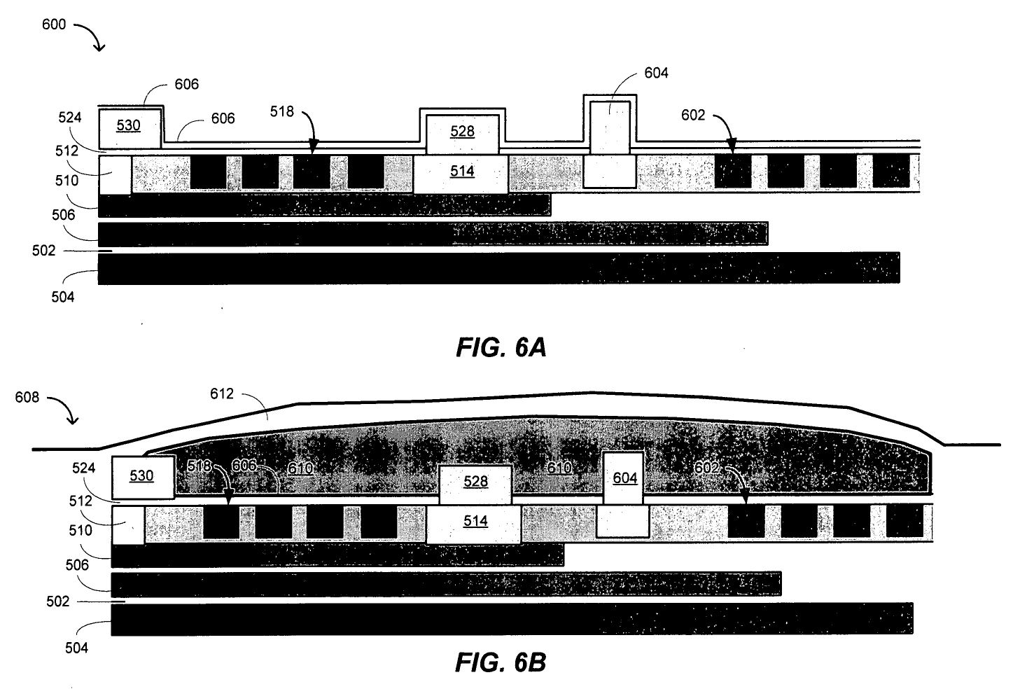

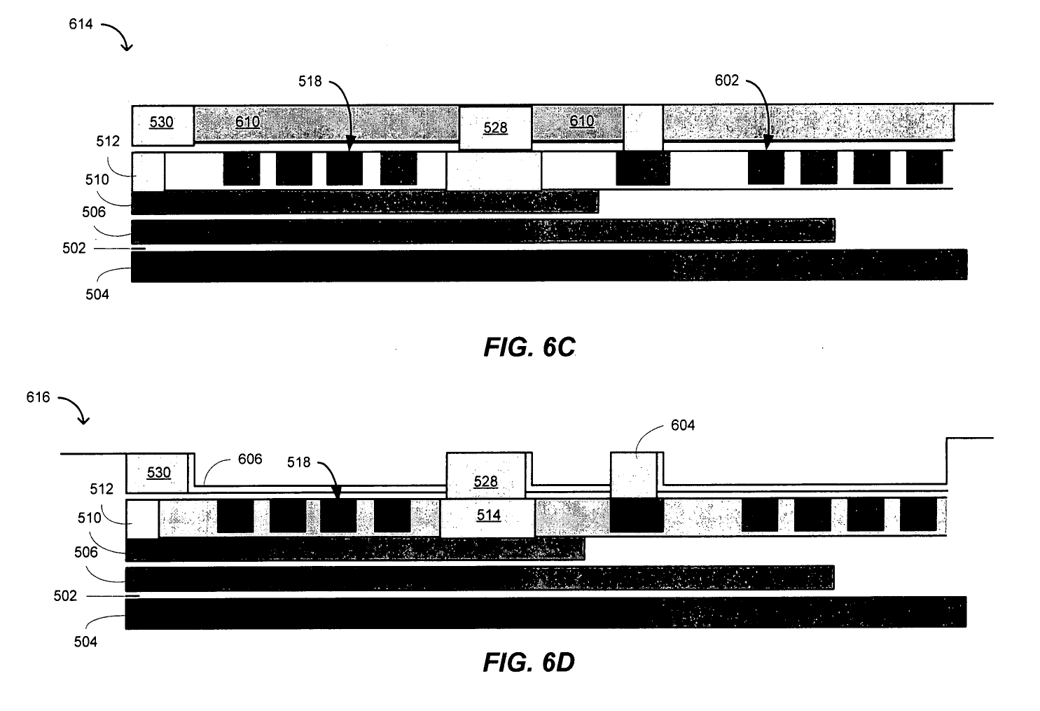

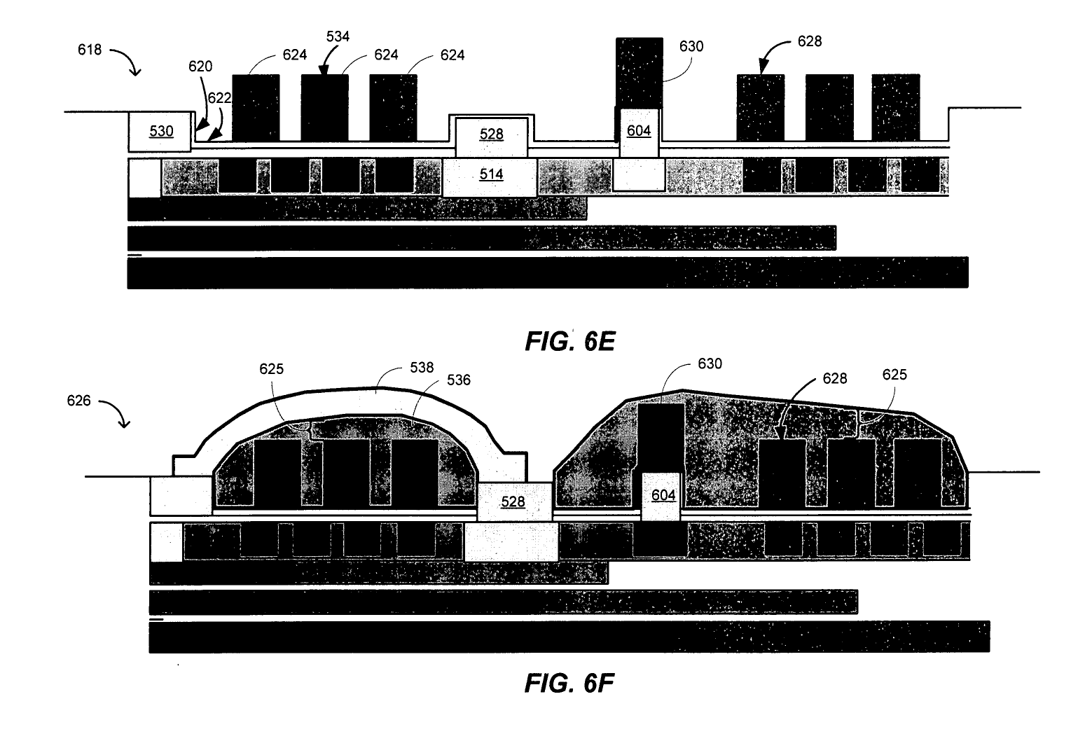

FIGS. 6(a)-(f) show some of the relevant steps for processing or manufacturing the write head 508 to increase the height of the coil 534. In FIG. 6(a), at step 600, the structures of FIG. 5 up to the build-up of the P2 pole tip 530 and back gap layer 528 is shown and they are the same as those shown and described relative to FIG. 5. Additionally, the back turn of the coil 518, i.e. the coil ending 602, is shown along with a center tab 604, which are also known in prior art write heads.

At step 600, an alumina gap layer 606 is deposited onto the P2 pole tip 530, the back gap layer 528 and the write gap layer 524. In one embodiment of the present invention, as shown in FIG. 6(e), the center tab 604 is made of a P2 material and formed in the same manner as that of the P2 pole tip 530 and the back gap layer 528 are formed.

FIG. 6(b) shows step 608 where a pancake of photoresist or insulation layer 610 is deposited onto the gap layer 606 to cover the area where the coil 534 will reside. The gap layer 606 is generally 0.05 to 1 microns, in thickness, and in an example embodiment, it is 0.2 microns. In one embodiment of the present invention, next, a hard bake process is employed where high temperatures, such as 200 degrees Celsius is applied to bake the photoresist. In an alternative embodiment, a soft bake photoresist is used in place of the hard bake process. Additionally, an alumina layer 612 is filled in to cover the top of the insulation layer 610, as high up onto the insulation layer 610 as is desired to perform a chemical mechanical polishing (CMP) process.

Next, in FIG. 6(c), at step 614, a CMP process is performed to level or flatten the alumina layer 612 and the insulation layer 610 to prepare for the formation of the coil 534. It should be noted that the center tab 604 undergoes the same process as that described relative to FIGS. 6(a), (b) and (c), that is, the layer 606 is deposited thereon during the step 600, the layer 610 is deposited, as described in step 608 and the CMP processed of step 614 is performed thereon.

Next, at step 616 of FIG. 6(d), the insulation layer 610 is removed by using reactive ion etching (RIE) if it is a hard baked photoresist, which is preferred over soft bake photoresist. The insulation layer 610 is first applied to save the space(s) for the coil (or copper) to be plated therein and to allow the CMP process to be performed. After the CMP process, the insulation layer 610 is removed by RIE and then coil is plated in its place or space(s) created from such removal. Stated differently, the layer 610 is deposited, at step 608, specifically to create spaces or voids wherein coil or copper is to be deposited. By depositing the layer 610 in the coil space first, the alumina filling and CMP steps, described above, are allowed to take place without blocking the coil space with alumina. After the CMP step, the whole wafer is lapped flat and the spaces where coil is to be formed, are filled with photoresist, which is exposed for removal thereof, if it is hard baked photoresist. In an alternative embodiment, soft baked photo resist may be used as place holder/insulator 610 and it is removed by a RIE process.

In FIG. 6(e), at step 618, a number of steps are performed to form the coils 534 and 628. Namely, a coil (or metal) seed layer 620 is deposited onto the gap layer 606 followed by the formation of the copper coil 534, which includes the steps of processing of coil photoresist to define a coil pattern, electroplating copper into the pattern, removing the processed coil photoresist and lastly, sputter-etching or ion milling to remove the seed layer 620 from the exposed areas.

A second ending coil 628 is formed of copper plated in the back end coil and copper 630 is plated to form the center tab of the coil using the steps described above, which are performed at the same time as formation of the coil 534.

As may be apparent to the reader, the height of the copper 624 is increased in relation to prior art. In an example embodiment, this height increase is experienced to be 80 to 120%. An example of the height of the coil 534 or the coil 628 (or the copper 624) is known to be 2 to 5 microns. In one embodiment, the height of the coil 534 or the coil 628 is 3.5 microns. The space between the P2 pole tip 530 and the back gap layer 528, which is the area 439 of FIG. 2, is now, in large part, consumed by the added length of the coil 534.

Next, at step 626, in FIG. 6(f), the structure of FIG. 6(e) is modified further in that a photoresist layer, or the insulation layer 536, is deposited in between and on top of the coil 534 and the coil 628 and the copper 630 and hard baked, as done by prior art techniques to insulate the coils 534 and 628 and the P3 magnetic layer 538 is then formed. Next, while not shown in FIG. 6(f), a seed layer is sputtered atop the insulation layer 536 and the P3 magnetic layer 538 is formed on top of the insulation layer 536. At the seed layer removal step of the present invention, however, this sputtering does not introduce a risk of exposing the coil 534 to cause shorting because the copper that is plated to form the coils 534 and 628 is far enough away from the top surface of the insulation layer 536. It should be noted however, that the portion of the insulation layer 536 that is shown to be above the coils 534 and the coils 628 and below the P3 magnetic layer 538, shown at 625, remains the same in height as that of prior art, which effectuates maintaining the yoke short, otherwise, a dome-type yoke would be formed with a higher or taller area at 625. It should further be noted that the coils 534 and 628 of the present invention, extend below the top of the P2 pole tip 530, which is not the case in prior art structures, such as shown in FIG. 2.

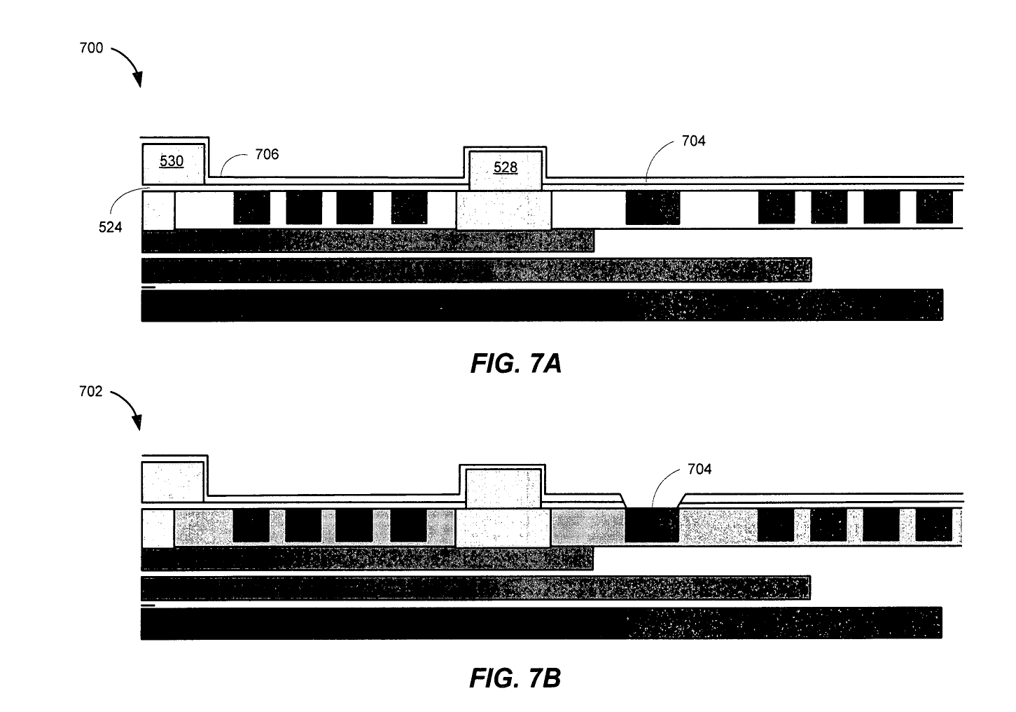

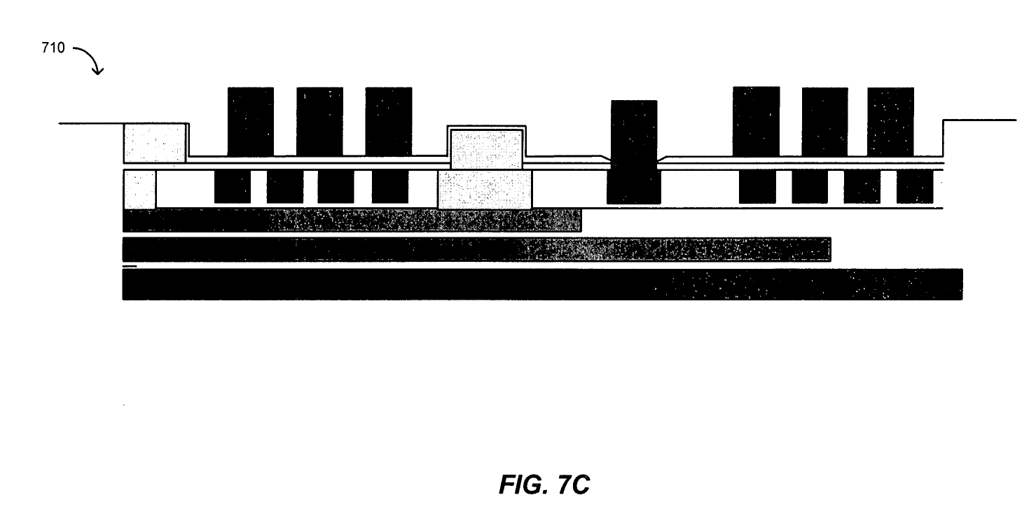

FIGS. 7(a)-(c) show the relevant steps for an alternative formation and embodiment of the write head 508 wherein the center tab 704 is shown to include no P2 material. With particular reference to FIG. 7(a), at step 700, an alumina gap layer 706 is deposited onto the P2 pole tip 530, the back gap layer 528 and the write gap layer 524. In the embodiment of FIGS. 7(a)-7(c), the center tab 704 is not plated with P2 material. Next, to form the structure 702 of Fig. (b), the same steps as that shown and discussed with reference to FIGS. 6(b)-(d) are followed.

Note that RIE is employed to etch the portion of the alumina gap layer 706 that has been formed on top of the center tab 704. Next, the steps shown and discussed relative to FIG. 6(e) are performed to form the structure 710 of FIG. 7(c).

It should be noted that the figures referred to herein are not drawn to scale.

Although the present invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claimed is:

1. A method of manufacturing a write head having a first and second layer coil wherein formation of the second layer coil comprising:
applying a first insulation layer;
baking the first insulation layer;
applying a chemical mechanical polishing (CMP) process to level the first insulation layer;
removing the leveled first insulation layer;
depositing a coil photoresist layer into the coil spaces;
plating copper on top of the deposited coil photoresist layer and between the P2 pole tip and the back gap layer to form a coil;
applying a second insulation layer to insulate the plated copper; and
sputtering a seed layer on top of the second insulation layer while avoiding exposure of the plated copper to a P3 magnetic layer.

2. A method of manufacturing as recited in claim 1 further including the step of depositing a gap layer atop and between the P2 pole tip and a back gap layer prior to applying the first insulation layer.

3. A method of manufacturing as recited in claim 2 wherein the step of depositing the gap layer includes applying the first insulation layer in between the P2 pole tip and the back gap layer.

4. A method of manufacturing as recited in claim 2 further including the step of hard baking after the step of depositing the gap layer.

5. A method of manufacturing as recited in claim 2 further including the step of soft baking after the step of depositing the gap layer.

6. A method of manufacturing as recited in claim 1 further including the step of filling an alumina layer to cover the first insulation layer.

7. A method of manufacturing as recited in claim 1 further including the step of forming a P3 magnetic layer on top of the seed layer.

8. A method of manufacturing as recited in claim 1 wherein the step of removing is performed using reactive ion etching.

9. A method of manufacturing as recited in claim 1 wherein the step of removing is performed using soft baking process.

10. A method of manufacturing as recited in claim 1 further including the steps of forming a center tap made of P2 material and plating copper thereupon.

11. A method of manufacturing as recited in claim 1 further including the steps of forming a center tap made of by plating copper thereby avoiding the use of P2 material.

12. A structure formed in a write head comprising:
a P2 pole tip;
a back gap layer;
a first insulation layer applied on top and in between the P2 pole tip and the back gap layer;
coil, formed of copper, and developed on top of the first insulation layer and extending below the top of the P2 pole tip;
a second insulation layer pancaking the coil to insulate the same; and
P3 magnetic layer formed on top of the second insulation layer, the coil reducing coil resistance yet avoiding shorting with the P3 magnetic layer.

13. A structure as recited in claim 12 further including a gap layer deposited atop and between the P2 pole tip and the back gap layer.

14. A structure as recited in claim 12 further including an alumina layer filled to cover the first insulation layer.

15. A structure as recited in claim 12 further including a seed layer sputtered on top of the second insulation layer.

16. A structure as recited in claim 12 including a center tap made of copper and P2 plated material.

17. A structure as recited in claim 12 including a center tap made of copper.

18. A disc drive comprising:
a write head including,
a P2 pole tip;
a back gap layer;
a first insulation layer applied on top and in between the P2 pole tip and the back gap layer;
coil, formed of copper, and developed on top of the first insulation layer;
a second insulation layer pancaking the coil to insulate the same; and
P3 magnetic layer formed on top of the second insulation layer, the coil having a height large enough to reduce coil resistance yet avoiding shorting with the P3 magnetic layer.

19. A structure formed in a write head comprising:
a P2 pole tip; a back gap layer;
a first insulation layer applied on top and in between the P2 pole tip and the back gap layer;
coil, formed of copper, and developed on top of the first insulation layer and extending below the top of the P2 pole tip, said coil having an aspect ratio defined by a ratio of the height of the coil to the width of the coil, said aspect ratio being 1:1;
a second insulation layer pancaking the coil to insulate the same; and
P3 magnetic layer formed on top of the second insulation layer, the coil reducing coil resistance yet avoiding shorting with the P3 magnetic layer.

20. A structure as recited in claim 19 further including a gap layer deposited atop and between the P2 pole tip and the back gap layer.

21. A structure as recited in claim 19 further including an alumina layer filled to cover the first insulation layer.

22. A structure as recited in claim 19 further including a seed layer sputtered on top of the second insulation layer.

23. A structure as recited in claim 19 including a center tap made of copper and P2 plated material.

24. A structure as recited in claim 19 including a center tap made of copper.

25. A structure as recited in claim 19 including a non-magnetic dielectric material filled below the coil.

26. A structure as recited in claim 25 wherein the dielectric material is made of a metallic material.

27. A structure as recited in claim 25 wherein the dielectric material is made of a non-metallic material.

28. A structure formed in a write head comprising:
a P2 pole tip;
a back gap layer;
a first insulation layer applied on top and in between the P2 pole tip and the back gap layer;
coil, formed of copper, and developed on top of the first insulation layer;
a second insulation layer pancaking the coil to insulate the same; and
P3 magnetic layer formed on top of the second insulation layer, the conductivity of an area defined below the P3 magnetic layer and extending between the P2 pole tip and the back gap layer but not below the first insulation layer is 40-50%.

29. A structure as recited in claim 28 further including a gap layer deposited atop and between the P2 pole tip and the back gap layer.

30. A structure as recited in claim 28 further including an alumina layer filled to cover the first insulation layer.

31. A structure as recited in claim 28 further including a seed layer sputtered on top of the second insulation layer.

32. A structure as recited in claim 28 including a center tap made of copper and P2 plated material.

33. A structure as recited in claim 28 including a center tap made of copper.

34. A structure as recited in claim 28 including a non-magnetic dielectric material filled below the coil.

35. A structure as recited in claim 34 wherein the dielectric material is made of a metallic material.

36. A structure as recited in claim 34 wherein the dielectric material is made of a non-metallic material.
